(19) United States
(12) Patent Application Publication
(10) Pub. No.: US 2010/0043538 A1
(43) Pub. Date: Feb. 25, 2010

(54) METHODS OF AND APPARATUS FOR DETERMINING THE VISCOSITY OF HEAVY OIL

(76) Inventors: Yuesheng Cheng, Edmonton (CA); Abdel M. Kharrat, Edmonton (CA)

Correspondence Address: SCHLUMBERGER CANADA LIMITED, 9450 17TH AVE, EDMONTON, AB, T6N 1M9, CA

(21) Appl. No.: 12/536,230

(22) Filed: Aug. 5, 2009

(30) Foreign Application Priority Data
Aug. 20, 2008 (CA) 2,638,949

(51) Int. Cl. G01N 11/00

(52) U.S. Cl. 73/54.42

(57) ABSTRACT

The viscosity of a heavy oil is estimated according to a power law equation which relates the heavy oil viscosity to a function of the assumed, measured, or estimated glass transition temperature of the heavy oil and the measured temperature of the heavy oil.

### BACKGROUND OF THE INVENTION

1. Field of the Invention

This invention relates broadly to the investigation of geological formations. More particularly, this invention relates to methods of determining the viscosity of a heavy oil at any temperature based on a glass transition temperature T_{g} of the heavy oil. Apparatus for implementing the methods are provided. For purposes herein, a “heavy oil” shall be defined and understood to be any oil having an API gravity of 22.3 degrees or less.

2. Description of Related Art

With conventional oil reserves rapidly depleting worldwide, deposits of heavy oils and tar sands, which contain significant energy reserves, are becoming increasingly important. High viscosity is a major concern in the recovery of these unconventional oils. Usually, thermal methods, particularly steam drive and steam soak, are used to recover heavy oils and bitumen. Thermal methods rely on several displacement mechanisms to recover oil, but the most important is the reduction of crude viscosity with increasing temperature. Therefore, it is pivotal to understand the heavy oil viscosity-temperature behavior.

Currently, heavy oil viscosity is usually predicted based on the principles of equations of state (EOS) in which the fluid composition is used in conjunction with tuned EOS parameters. However, when the heavy oil composition is dramatically different from the model system, the prediction results are effectively useless. There is no generally reliable method which can characterize heavy oil viscosity behavior over a wide range of heavy oil samples (worldwide) and temperatures (10-240° C.).

### BRIEF SUMMARY OF THE INVENTION

In accordance with one aspect of the invention, the viscosity of a heavy oil can be estimated according to a power law equation which relates the heavy oil viscosity to a function of the assumed, measured, or estimated glass transition temperature of the heavy oil and the measured temperature of the heavy oil.

According to another aspect of the invention, the power law equation which relates the heavy oil viscosity η to the glass transition temperature T_{g} and the measured temperature T is ln(η)=a+b(T/T_{g})^{c}, where “a”, “b”, and “c” are constants, and “b” has a value between 18 and 22, and “c” has a value between −3.4 and −3.2.

In one embodiment of the invention, the glass transition temperature of a heavy oil sample is measured with a tool such as a differential scanning calorimeter or dielectric spectroscope, and an estimate of the viscosity of the heavy oil sample at any temperature is determined according to the power law equation.

In another embodiment of the invention, the viscosity of a heavy oil sample is measured at a given temperature with a tool such as a viscometer or a nuclear magnetic resonance (NMR) tool. The glass transition temperature is then calculated from the viscosity and temperature information according to the power law equation. Then, the viscosity of the heavy oil sample can be estimated at any other temperature according to the power law equation.

In a further embodiment, the temperature of a heavy oil sample is measured, and the glass transition temperature of the heavy oil is estimated. Then, using the power law equation, the viscosity of the heavy oil sample is estimated.

Objects and advantages of the invention will become apparent to those skilled in the art upon reference to the detailed description taken in conjunction with the provided figures.

### BRIEF DESCRIPTION OF THE DRAWINGS

FIG. 1 is a graph showing the relationship between the viscosity and temperature of fourteen different heavy oil samples.

FIG. 2 is a logarithmic plot showing the viscosities of the fourteen different heavy oil samples as a function of the reduced glass transition temperature (T/T_{g}).

FIG. 3 is a logarithmic plot showing the viscosities of the fourteen different heavy oil samples as a function of the adjusted reduced glass transition temperature (T/Tᵣ), with a power law equation curve fit to the data.

FIGS. 4A-4C are flow diagrams of three methods of the invention.

FIG. 5 is schematic diagram of a borehole tool capable of implementing the methods of the invention.

### DETAILED DESCRIPTION OF THE INVENTION

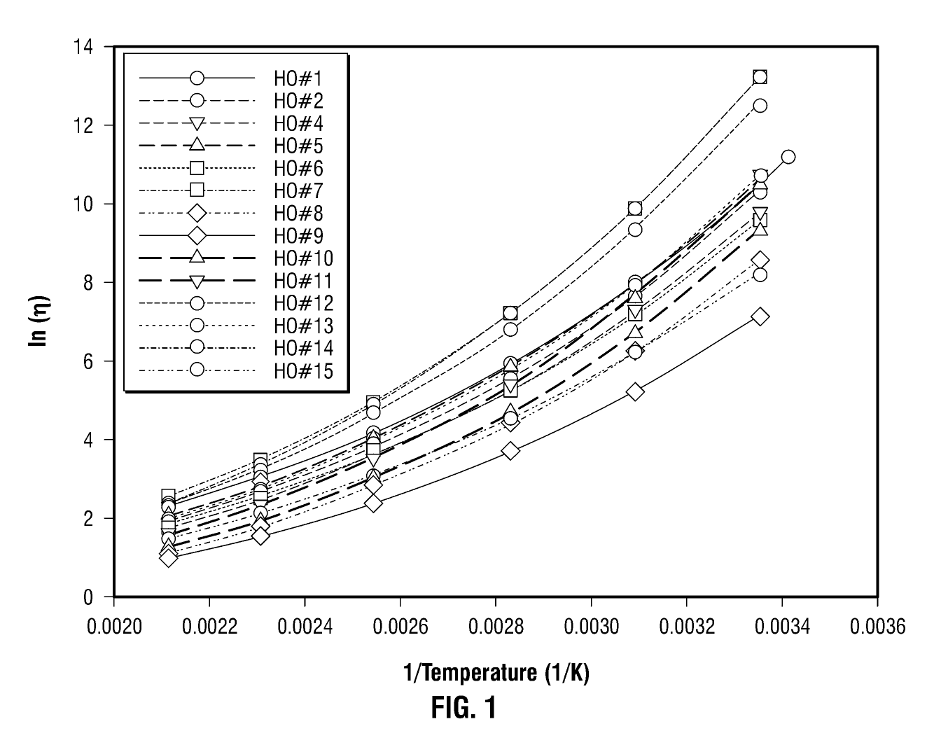

Fourteen heavy oil samples were collected from different regions of the world. Their viscosities at different temperatures were measured with a viscometer. FIG. 1 shows the relationship between the viscosity η and the temperature T for each heavy oil sample, where the “x” axis is the inverse of the temperature (Kelvin), and the “y” axis is the natural log of the heavy oil sample viscosity.

The temperature and viscosity of a polymer can be related to each other via the glass transition viscosity η_{g} (i.e., the viscosity at the glass transition temperature) and glass transition temperature T_{g} of the polymer according to the William-Landel-Ferry (WLF) equation (Williams, M. et al., Journal of the American Chemical Society 77, 3701 (1955):

$$ln \frac{η}{{η}_{g}} = \frac{- C 1 * ( T - {T}_{g} )}{C 2 + ( T - {T}_{g} )} \qquad ( 1 )$$

where C1 and C2 are constants. Using the WLF equation and the procedures set forth in the William, M. et al. article, it is possible to use the temperature and viscosity data and obtain a determination of the glass transition temperature T_{g} (as well as unknowns C1, C2, and η_{g}).

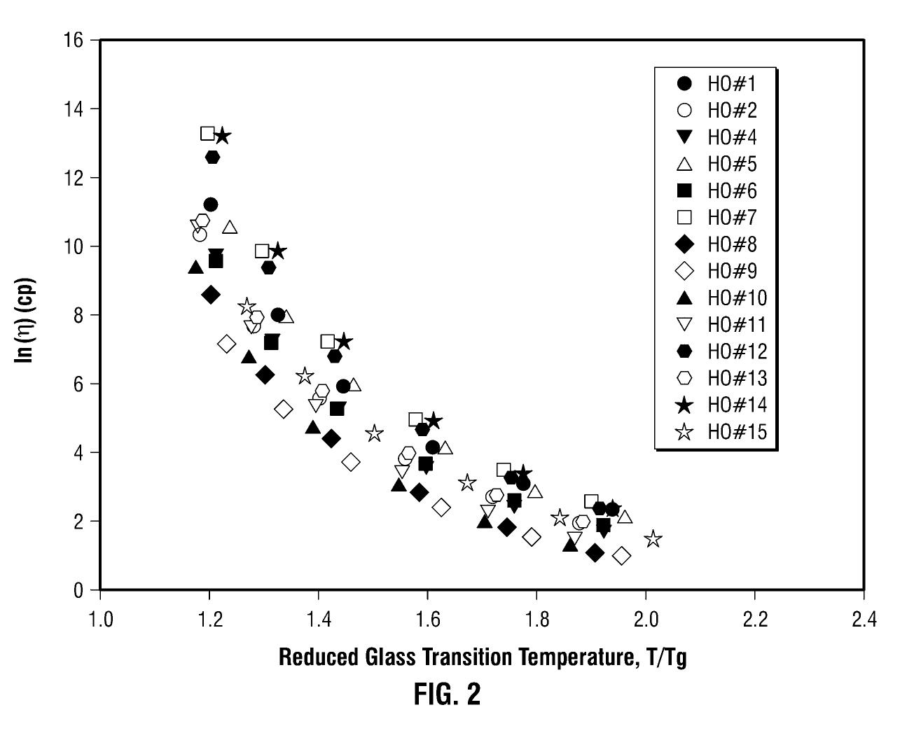

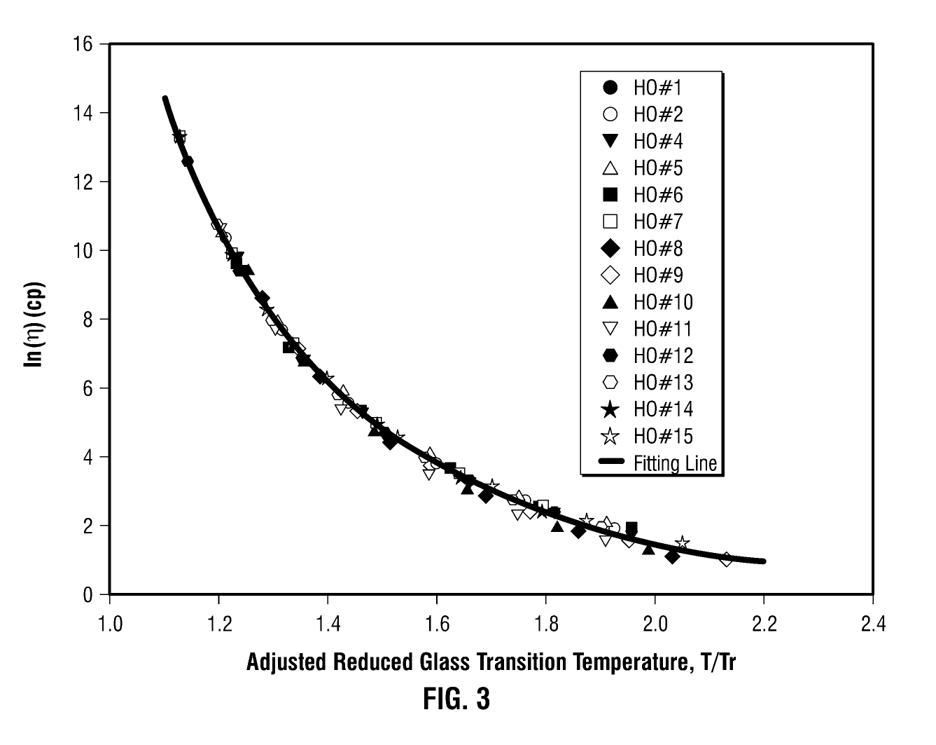

Having obtained the glass transition temperature for each sample, the heavy oil viscosity data for each sample was plotted against the reduced glass transition temperature (i.e., T/T_{g}) as seen in FIG. 2. The results show that the relationships between the viscosities of the heavy oils and their reduced glass transition temperatures are very similar, but deviate from a single curve. Considering that the glass transition temperature T_{g} is cooling rate dependent, even the best experimental determination of T_{g} can only be thought of as close to the calorimetric ideal glass transition temperature. Therefore, it is reasonable that by adjusting the glass transition temperatures T_{g} of the heavy oil samples within a range of ±10% to obtain adjusted glass transition temperatures Tᵣ, the data relating the viscosity and the adjusted reduced glass transition temperature T/Tᵣ can be forced to fit well along a single master curve as shown in FIG. 3. The master curve (solid line in FIG. 3) obeys the power law equation

ln η=a+b(T/Tᵣ)^{c} (2)

where “a”, “b”, and “c” are constants. More particularly, the data can be empirically fitted according to the following power law equation:

ln η=−0.5734+20.4095(T/Tᵣ)^{-3.3018}. (3)

With constant a=−0.5734, constant b=20.4095, and constant c=−3.3018, a good estimation of the viscosity is obtained for the fourteen samples at various temperatures; i.e., R²=0.97.

In order to fit the data along the master curve, the glass transition temperatures T_{g} of the samples found according to fitting results of the Equation (1) were adjusted as set forth in Table 1:

TABLE 1

| Heavy Oil Sample | T_{g} (° K) | Tᵣ (° K) | Tᵣ/T_{g} |
|---|---|---|---|
| HO #1 | 244 | 248 | 1.0176 |
| HO #2 | 252 | 246 | 0.9750 |
| HO #4 | 246 | 242 | 0.9829 |
| HO #5 | 241 | 248 | 1.0270 |
| HO #6 | 246 | 242 | 0.9837 |
| HO #7 | 249 | 264 | 1.0602 |
| HO #8 | 245 | 233 | 0.9510 |
| HO #9 | 242 | 222 | 0.9174 |
| HO #10 | 254 | 238 | 0.9362 |
| HO #11 | 253 | 248 | 0.9802 |
| HO #12 | 247 | 261 | 1.0567 |
| HO #13 | 251 | 249 | 0.9920 |
| HO #14 | 244 | 264 | 1.0820 |
| HO #15 | 235 | 231 | 0.9830 |
| Average | 246.36 | 245.36 | 0.9961 |

From Table 1, several conclusions and suppositions can be drawn. First, on average, T_{g} and Tᵣ are within one percent of one another. Therefore, in relating viscosity to temperature, Equation (3) can be modified to

ln η=−0.5734+20.4095(T/T_{g})^{-3.3018}. (4)

Second, for each individual heavy oil sample, Tᵣ was within ±10% of T_{g}. As seen in FIG. 3, these adjustments permitted the data for the samples to fall on or very close to a single curve. Thus, it is expected that Equation (4) will provide an excellent correlation between viscosity and the reduced glass transition temperature for most heavy oil samples. Third, even though an excellent correlation is expected using Equation (4), it will be appreciated that, because adjustments were required to obtain a close fit, different values for constants “a”, “b”, and “c” could be utilized and still provide good results. For example, it has been determined that good results can be obtained if constant “b” is between 18 and 22. Likewise, good results can be obtained if constant “c” has a value between −3.4 and −3.2. Constant “a” is an offset value which may result from the curve fitting, and therefore constant “a” may take a relatively wide range of values. Fourth, all of the glass transition temperatures were seen to be within ±5% of the average glass transition temperature. Thus, in the absence of glass transition temperature data with respect to a given heavy oil sample, it may be possible to assume that T_{g}=246° K.

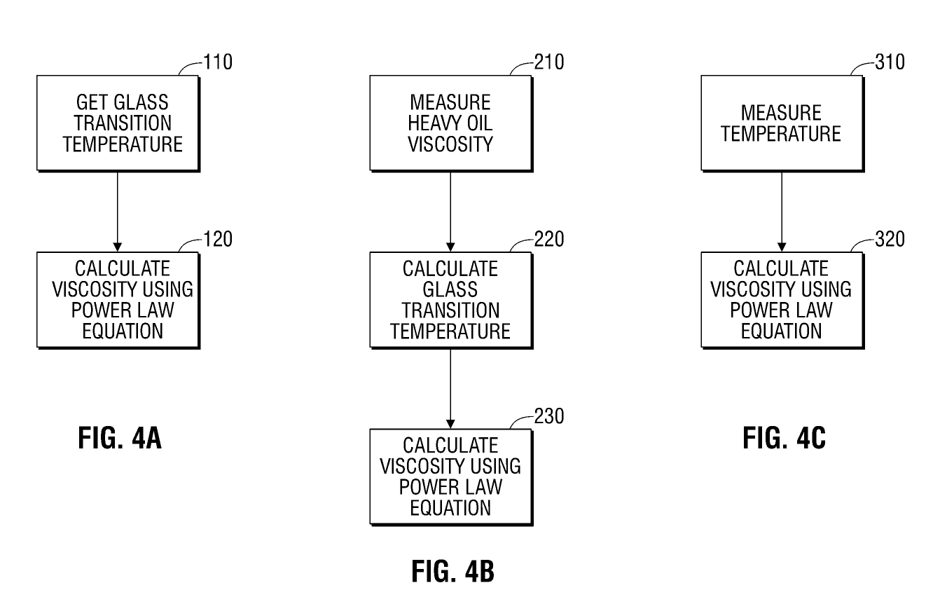

Given the conclusions and suppositions set forth above, a first method is seen in FIG. 4A. At 110, the glass transition temperature T_{g} of a heavy oil sample is found in any manner or is measured with lab equipment (e.g., a differential scanning calorimeter or a dielectric spectroscope). Then, at 120, the viscosity η of that heavy oil sample or a similar heavy oil sample (e.g., an in situ sample from the same reservoir) at any temperature T is estimated according to the power law equation ln(η)=a+b(T/T_{g})^{c}, where “a”, “b”, and “c” are constants. Preferably, constant “b” has a value between 18 and 22, and constant “c” has a value between −3.4 and −3.2. More preferably, constant “a”=−0.5734, constant “b”=20.4095, and constant “c”=−3.3018.

FIG. 4B sets forth a second method. At 210, the viscosity of a heavy oil sample is measured with a viscometer or using nuclear magnetic resonance (NMR) techniques. Where NMR techniques are used, the viscosity may be found according to the correlations described in Canadian Patent Application ______, entitled “Methods for Determining In Situ the Viscosity of Heavy Oil”, filed Aug. 6, 2008. With the viscosity and temperature information, at 220, the glass transition temperature T_{g} is calculated (estimated) according to the power law equation ln(η)=a+b(T/T_{g})^{c}, where “a”, “b”, and “c” are constants. Preferably, constant “b” has a value between 18 and 22, and constant “c” has a value between −3.4 and −3.2. More preferably, constant “a”=−0.5734, constant “b”=20.4095, and constant “c”=−3.3018. Then, at 230, the viscosity η of that heavy oil sample or a similar heavy oil sample (e.g., an in situ sample from the same reservoir) at any temperature T is estimated according to the same power law equation with the calculated value of the glass transition temperature T_{g} from step 220 used in the equation.

Using the second method, five heavy oil samples (A-E) from different parts of the world were analyzed. A first viscosity was measured for each heavy oil sample using a viscometer at a first temperature (as seen in Tables 2-6 below). Then the glass transition temperature Tg was calculated for that heavy oil sample according Equation (4) above. The viscosities for different temperatures for that heavy oil sample were then predicted using Equation (4) using the calculated glass transition temperature. The predicted viscosities were then compared to the viscosities measured by the viscometer at those temperatures. The results are set forth in Tables 2-6 below:

TABLE 2
Viscosity Predictions for Live Heavy Oil Sample A (API - 9.7)

| Temperature | Temperature | Capillary | Predicted | Relative Error, |
|---|---|---|---|---|
| ° C. | ° K | viscosity, cp | viscosity, cp | % |
| 30 | 303.15 | 6253 | — | — |
| 20 | 293.15 | 19,123 | 18,615 | −2.6 |
| 10 | 283.15 | 60,019 | 65,848 | 9.7 |

TABLE 3
Viscosity Predictions for Live Heavy Oil Sample B (API - 16.0)

| Temperature | Temperature | Capillary | Predicted | Relative Error, |
|---|---|---|---|---|
| ° C. | ° K | viscosity, cp | viscosity, cp | % |
| 50 | 323.15 | 1241 | — | — |
| 90 | 363.15 | 139 | 106 | −23.9 |
| 125 | 398.15 | 40 | 27 | −33.5 |
| 160 | 433.15 | 18 | 11 | −39.9 |
| 200 | 473.15 | 9 | 5 | −41.7 |

TABLE 4
Viscosity Predictions for Live Heavy Oil Sample C (API - 8.0)

| Temperature | Temperature | Capillary | Predicted | Relative Error, |
|---|---|---|---|---|
| ° C. | ° K | viscosity, cp | viscosity, cp | % |
| 80 | 353.15 | 195 | — | — |
| 150 | 423.15 | 16 | 14 | −12.0 |
| 195 | 468.15 | 6 | 6 | 0 |

TABLE 5
Viscosity Predictions for Live Heavy Oil Sample D (API - 11.7)

| Temperature | Temperature | Capillary | Predicted | Relative Error, |
|---|---|---|---|---|
| ° C. | ° K | viscosity, cp | viscosity, cp | % |
| 100 | 373.15 | 250 | — | — |
| 149 | 422.15 | 40 | 33 | −18 |
| 190 | 463.15 | 15 | 11 | −27 |
| 240 | 513.15 | 5 | 5 | 0 |

TABLE 6
Viscosity Predictions for Live Heavy Oil Sample E (API - 13.7)

| Temperature | Temperature | Capillary | Predicted | Relative Error, |
|---|---|---|---|---|
| ° C. | ° K | viscosity, cp | viscosity, cp | % |
| 100 | 373.15 | 67 | — | — |
| 149 | 422.15 | 16 | 14 | −12.5 |
| 189.5 | 462.65 | 7 | 6 | −14.2 |
| 240 | 513.15 | 3 | 3 | 0 |

It will be appreciated from the above Tables, that in three of the five examples (Samples A, C, and E), the relative error between the predicted viscosity and the measured viscosity was very small; i.e., under (−)15%. In a fourth (Sample D) of the five examples, the relative error was up to (−)27%, which is quite small relative to prior art prediction techniques. In the fifth sample (Sample B), the relative error was still less (−42%) than typical prior art prediction techniques.

A third method is seen in FIG. 4C. The temperature of a heavy oil sample is measured at 310. Then, at 320, the viscosity η of that heavy oil sample at any temperature T is estimated according to the power law equation ln(η)=a+b(T/d246)^{c}, where “a”, “b”, “c” and “d” are constants. Preferably, constant “b” has a value between 18 and 22, constant “c” has a value between −3.4 and −3.2, and constant “d” has a value between 0.95 and 1.05. More preferably, constant “a”=−0.5734, constant “b”=20.4095, constant “c”=−3.3018, and constant “d”=1.

Using the third method, the viscosities for the five heavy oil samples (Samples A-E) were predicted according to Equation (4) above and compared to the measured viscosities at those temperatures. The results are set forth in Tables 7-11 below:

TABLE 7
Viscosity Predictions for Live Heavy Oil Sample A (API - 9.7)

| Temperature | Temperature | Capillary | Predicted | Relative Error, |
|---|---|---|---|---|
| ° C. | ° K | viscosity, cp | viscosity, cp | % |
| 30 | 303.15 | 6253 | 15,776 | 152 |
| 20 | 293.15 | 19,123 | 52,339 | 174 |
| 10 | 283.15 | 60,019 | 209,911 | 250 |

TABLE 8
Viscosity Predictions for Live Heavy Oil Sample B (API - 16.0)

| Temperature | Temperature | Capillary | Predicted | Relative Error, |
|---|---|---|---|---|
| ° C. | ° K | viscosity, cp | viscosity, cp | % |
| 50 | 323.15 | 1241 | 2250 | 81 |
| 90 | 363.15 | 139 | 159 | 14 |
| 125 | 398.15 | 40 | 36 | −10 |
| 160 | 433.15 | 18 | 13 | −28 |
| 200 | 473.15 | 9 | 6 | −34 |

TABLE 9
Viscosity Predictions for Live Heavy Oil Sample C (API - 8.0)

| Temperature | Temperature | Capillary | Predicted | Relative Error, |
|---|---|---|---|---|
| ° C. | ° K | viscosity, cp | viscosity, cp | % |
| 80 | 353.15 | 195 | 274 | 40.7 |
| 150 | 423.15 | 16 | 17 | 6.3 |
| 195 | 468.15 | 6 | 6 | 0 |

TABLE 10
Viscosity Predictions for Live Heavy Oil Sample D (API - 11.7)

| Temperature | Temperature | Capillary | Predicted | Relative Error, |
|---|---|---|---|---|
| ° C. | ° K | viscosity, cp | viscosity, cp | % |
| 100 | 373.15 | 250 | 98 | −60.8 |
| 149 | 422.15 | 40 | 17 | −57.5 |
| 190 | 463.15 | 15 | 7 | −53.4 |
| 240 | 513.15 | 5 | 3 | −40 |

TABLE 11
Viscosity Predictions for Live Heavy Oil Sample E (API - 13.7)

| Temperature | Temperature | Capillary | Predicted | Relative Error, |
|---|---|---|---|---|
| ° C. | ° K | viscosity, cp | viscosity, cp | % |
| 100 | 373.15 | 67 | 98 | 46.3 |
| 149 | 422.15 | 16 | 17 | 6.3 |
| 189.5 | 462.65 | 7 | 7 | 0 |
| 240 | 513.15 | 3 | 3 | 0 |

Various conclusions can be drawn from Tables 7-11. The range of relative error using the third method is considerably greater than the range of relative error using the second method. This suggests that it is beneficial to know or measure the glass transition temperature in finding the viscosity of a heavy oil. However, the relative error of the third method still matches or betters that of typical prior art results.

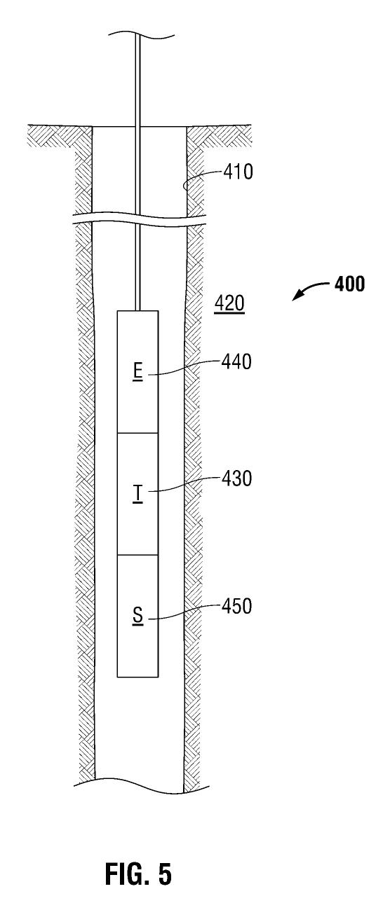

A tool for finding the in situ viscosity of a heavy oil sample is shown in FIG. 5. More particularly, tool 400 is a borehole tool which is located in a borehole 410 traversing earth formation 420. Borehole tool 400 includes a temperature sensor 430, electronics 440, and, optionally, a sample collection module 450. The electronics 440 are provided to transmit the temperature information uphole. Optionally, the electronics 440 can include processing means (e.g., a microprocessor or digital signal processor, or dedicated electronics) for calculating the viscosity of heavy oil detected at a particular depth in the formation using the temperature sensed by temperature sensor 430, and using Equation (4) or an equation of the same form having different constants. If the glass transition temperature of the oil at that depth in the formation is known, that information may be used by the processing means. If not, a value of 246° K. (±5%) may be used. If the processing means is provided downhole, the resulting calculated viscosity value may be transmitted uphole. Otherwise, a processing means may be provided on the surface of the formation (or remotely) for taking the temperature information and generating a viscosity value. The viscosity value may be displayed on a display screen or on paper. If the borehole tool 400 is moved to various locations in the borehole, viscosity values may be generated for those locations, and the values may be displayed in a log format or in any other desired format.

There have been described and illustrated herein several embodiments of a method of determining in situ the viscosity of heavy oils, and apparatus for implementing the method. While particular embodiments of the invention have been described, it is not intended that the invention be limited thereto, as it is intended that the invention be as broad in scope as the art will allow and that the specification be read likewise. Thus, while it was disclosed that a particular number (fourteen) of oil samples were used to generate values for certain constants of the power law equation curve, it will be appreciated that other numbers of samples could be utilized. Also, while particular methods of finding the glass transition temperature of an oil sample were described, it will be appreciated that other techniques could be utilized. It will therefore be appreciated by those skilled in the art that yet other modifications could be made to the provided invention without deviating from its scope as claimed.

What is claimed is:

1. A method for determining the viscosity of a heavy oil, comprising:
a) measuring a first temperature T of the heavy oil; and
b) determining a first viscosity η of the heavy oil at said first temperature T according to a power law equation of the form ln(η)=a+b(T/T_{g})^{c}, where “a”, “b”, and “c” are constants, and T_{g} is the glass transition temperature of that heavy oil.

2. A method according to claim 1, wherein constant “b” has a value between 18 and 22.

3. A method according to claim 1, wherein constant “c” has a value between −3.4 and −3.2.

4. A method according to claim 2, wherein constant “c” has a value between −3.4 and −3.2.

5. A method according to claim 1, wherein constant “a”=−0.5734, constant “b”=20.4095, and constant “c”=−3.3018.

6. A method according to claim 1, wherein said heavy oil is located in a formation traversed by a borehole, and said temperature T is measured in situ.

7. A method according to claim 6, wherein said glass transition temperature T_{g} is set to d*246, where d is a constant having a value between 0.95 and 1.05.

8. A method according to claim 1, wherein said glass transition temperature T_{g} is measured with an instrument.

9. A method according to claim 4, wherein said glass transition temperature T_{g} is measured with an instrument.

10. A method according to claim 1, wherein said glass transition temperature T_{g} is obtained by obtaining a second viscosity value of said heavy oil at a second temperature, and calculating said glass transition temperature T_{g} by solving said power law equation for said glass transition temperature using said second viscosity value and said second temperature.

11. A method according to claim 4, wherein said glass transition temperature T_{g} is obtained by obtaining a second viscosity value of said heavy oil at a second temperature, and calculating said glass transition temperature T_{g} by solving said power law equation for said glass transition temperature using said second viscosity value and said second temperature.

12. An apparatus for determining the viscosity of a heavy oil, comprising:
a) means for measuring a first temperature T of the heavy oil; and
b) processing means for determining a first viscosity η of the heavy oil at said first temperature T according to a power law equation of the form ln(η)=a+b(T/T_{g})^{c}, where “a”, “b”, and “c” are constants, and T_{g} is the glass transition temperature of that heavy oil.

13. An apparatus according to claim 12, wherein constant “b” has a value between 18 and 22.

14. An apparatus according to claim 12, wherein constant “c” has a value between −3.4 and −3.2.

15. An apparatus according to claim 13, wherein constant “c” has a value between −3.4 and −3.2.

16. An apparatus according to claim 12, wherein constant “a”=−0.5734, constant “b”=20.4095, and constant “c”=−3.3018.

17. An apparatus according to claim 12, wherein said glass transition temperature T_{g} is set to d*246, where d is a constant having a value between 0.95 and 1.05.

18. An apparatus according to claim 15, wherein said glass transition temperature T_{g} is set to d*246, where d is a constant having a value between 0.95 and 1.05.
